(19) United States
(12) Patent Application Publication
(10) Pub. No.: US 2005/0058755 A1
(43) Pub. Date: Mar. 17, 2005

(54) Relocatable processing plant for extracting juice from citrus fruit and associated methods

(76) Inventor: Burgess Chambers, Winter Park, FL (US)

Correspondence Address: Henry Estevez;ALLEN, DRYER, DOPPELT, MILBRATH & GILCHRIST, P.A., Suite 1401, 255 South Orange Avenue, Orlando, FL, 32802-3791, US

(21) Appl. No.: 10/667,285

(22) Filed: Sep. 17, 2003

(51) Int. Cl. A23P 1/00

(52) U.S. Cl. 426/489

(57) ABSTRACT

A relocatable plant for citrus juice extraction includes several trailers which are connected together on site to form the relocatable plant. The plant includes a fruit handling trailer, a juicing trailer, a chilling trailer, a tank trailer, a generator trailer, a detachable walkway platform interconnecting the trailers and a plurality of entryways along the walkways for allowing ingress and egress of personnel. A method aspect of the invention includes obtaining fresh citrus juice on a commercial scale by stationing the relocatable plant on site at a citrus grove having fruit ready for harvest, and processing citrus fruit through the plant at a rate sufficient to produce at least 500 gallons of juice per hour of operation.

### RELATED APPLICATION

This application claims priority from co-pending utility patent application Ser. No. 09/573,578, which was filed on May 18, 2000, and which is incorporated herein by reference in its entirety.

### FIELD OF THE INVENTION

The present invention relates to the field of extracting juice from citrus fruit and, more particularly, to a relocatable apparatus for extracting juice from citrus fruit on-site at a grove, and associated methods.

### BACKGROUND OF THE INVENTION

Citrus fruit is commercially grown in large groves which may be spread out over a wide geographic area. The fruit must be harvested by hand when mature and transported by truck to a processing plant where the fruit is stored until the juice is extracted, processed, and packaged for sale. Other byproducts obtained during processing also have commercial value, for example, citrus oils used for making a variety of products, including organic cleaners, fragrance, flavorings, cattle feed, and others.

Processing plants for citrus fruit are usually sited within a citrus producing area for serving widely scattered grove operations. Accordingly, there must necessarily be transportation of fruit from the groves to a more or less central processing plant. A fixed citrus processing plant has high fixed and variable operating costs. Accordingly, such plants are generally inefficient unless they operate at near or above capacity. Growers experience the impact of these high costs as lower returns on their crops. The price of the citrus increases along the progression from grove, to processing plant, to packer, to retailer. Consequently, it is the citrus grower who by being at the bottom of the distribution chain obtains the lowest price per gallon of citrus juice. In today's market in the U.S. the citrus grower receives about seventy cents per gallon of citrus juice. The estimated cost of transporting the fruit from the grove to the processing plant is from about seven to about ten cents per gallon of finished juice. As transportation and processing costs are added to the product, however, the U.S. consumer today pays on the average of about five dollars per gallon for pasteurized juice. The grower not only receives a low return on his crop, but is also totally dependent on processors for moving his crop to the juice market.

In addition, just as with any other industrial facility, a citrus processing plant must be taken off-line at planned intervals for routine maintenance of the equipment. When one or more plants are inoperative, a glut of fresh fruit is created as the available processing capacity is exceeded by the supply of fruit. Under these conditions, it is likely that excess fruit will begin to spoil. This situation further drives down the price paid to the grower for fresh fruit, since the fruit will deteriorate unless timely processed. Even though there is an excess of fruit, the limited processing capacity continues to drive the market price of citrus juice. Consequently, the consumer does not benefit from a drop in fresh juice prices, even though fresh fruit is available in excess.

Furthermore, present industry practice requires that the citrus fruit withstand fairly severe handling, transportation to a processing facility, and at least several days' storage before the juice is extracted. For example, a field worker picks the fruit and deposits it into a sack usually worn around the shoulder. When the sack is full, the worker will dump the sackload into one of many tubs placed throughout the grove for the purpose. When the tub is filled, it is picked up by another worker with a machine known in the trade as a “goat”. The goat carries the filled tub to an open trailer, into which the fruit is then dumped. The trailer is filled with fruit as harvesting progresses, and then remains on-site until hitched to a tractor truck for transporting the fruit to a processing plant. In practice, the fruit will be in transit from the tree to a processing plant for about two to three days, during which time it remains in the open trailer. Upon arrival at the processing plant, the fruit is dumped into a hopper to await processing. Those skilled in the art know that this process causes fruit arriving at the processing plant to be bruised and usually very dirty.

### SUMMARY OF THE INVENTION

With the foregoing in mind, the present invention advantageously provides a relocatable apparatus for processing citrus fruit into juice on-site at a grove. An object of the invention is to reduce the cost of transportation fruit and the cost of processing the fruit into juice. In addition, the citrus grower may directly put this invention to use and may reduce or eliminate his dependence on regional processing plants by having the ability of extracting fresh citrus juice on-site at the grove, or at any other chosen location.

The relocatable processing apparatus provides the grower with the ability of deciding to which packaging plant juice will be sent, in effect creating a more decentralized market. For example, any dairy plant has the capability of pasteurizing and packaging fresh citrus juice, so that there are many potential packagers available in any given region. Rather than sending all the fresh fruit to a processor who then decides where the juice will be packaged and marketed, the grower will be able to choose a packager serving any desired market area. The relocatable processing apparatus of the present invention will substantially enable the grower to bypass the fixed processing plant, a costly intermediary, and to assume more complete responsibility for marketing his own product.

As an additional example, the relocatable plant could be positioned adjoining a citrus packing house so that fruit which do not meet the high standard required for boxed fresh fruit could be processed into juice on the spot. Moreover, the relocatable plant could be positioned adjacent a bottling plant, so that extracted juice could be bottled without any significant delay.

The grower may also use the relocatable processing plant according to the present invention for making up some or all the lost processing capacity when a regional plant is shut down for maintenance. The fresh citrus juice may then be taken directly to a packager for preparation for retail sale, bypassing the standard processing plant. When harvests exceed projections, the relocatable processing plant may be used to meet the need for additional processing capability. The relocatable processing plant also has the ability to follow a harvest season in growing regions as the fruit matures.

The apparatus and method of the invention for extracting citrus juice on-site at the grove also reduces the amount of handling and storage time to which the fruit is subjected. As noted above, fruit is normally hand picked, dumped into a tub, a filled tub is then dumped into a trailer which may sit for a day or two while fruit is getting dirtier and awaiting transportation to a processor, the fruit is then dumped into a hopper at the processing plant. In the present invention, the fruit is taken directly from the collection tub to the relocatable processing apparatus. The fruit, then, is less bruised and less contaminated with dirt. In the present method, the fruit may also be expected to carry a lower microbial load, since it goes substantially directly from the tree to the processing apparatus and does not sit in a trailer for any period of time.

In one embodiment of the invention, the relocatable plant for citrus juice extraction comprises several trailers having wheeled support platforms carrying the equipment thereon. A handling includes a fruit receiving hopper, a fruit washer, a sorting conveyor table, and a discharge conveyor. A juicing trailer has a feed conveyor positioned to receive fruit from the discharge conveyor of the fruit handling trailer, a plurality of juice extractors having fruit reamers and fed by said feed conveyor, a peel conveyor positioned to convey fruit peels from said plurality of extractors to a peel discharge chute, a refrigerated surge tank downstream from said plurality of extractors to receive extracted juice, and a first pump in fluid connection with said surge tank. A chilling trailer includes a chiller comprising a plurality of refrigerated pipes in fluid connection with said first pump for chilling juice to at least a temperature effective for stabilizing the juice. A tank trailer has a juice storage tank fluidly connected downstream from said chiller for receiving chilled juice therefrom, and a second pump having a juice transfer outlet fluidly connected to said storage tank for transferring stored juice to a transport tanker. A generator trailer bears a generator comprising an internal combustion engine and fuel supply therefor, said generator operably connected to provide power for said relocatable plant. Additionally, at least one walkway platform is detachably positioned along an external periphery of at least one of the trailers to support movement of personnel thereon, and a plurality of entryways are provided adjacent said plurality of walkways for ingress and egress of personnel.

Method aspects of the invention include a method of obtaining fresh citrus juice on a commercial scale by stationing the present relocatable plant adjacent a citrus grove having fruit ready for harvest, and harvesting and processing citrus fruit through the plant at a rate sufficient to produce at least 500 gallons of juice per hour of operation. Typically, this method would be continued until harvesting the grove is completed.

A more specific method employing the invention involves stationing on site at a citrus grove having citrus fruit about ready for harvest a handling trailer having a wheeled support platform carrying thereon a fruit receiving hopper, a fruit washer, a sorting conveyor table, and a discharge conveyor. The method continues by stationing adjoining the handling trailer a juicing trailer having a wheeled support platform carrying thereon a feed conveyor positioned to receive fruit from said discharge conveyor, a plurality of juice extractors having fruit reamers and fed by said feed conveyor, a peel conveyor positioned to convey fruit peels from said plurality of extractors to a peel discharge chute, a refrigerated surge tank downstream from said plurality of extractors to receive extracted juice, and a first pump in fluid connection with said surge tank. Still continuing, the method calls for stationing a chilling trailer adjacent said juicing trailer, the chilling trailer having a wheeled support platform carrying thereon a chiller comprising a plurality of refrigerated pipes in fluid connection with said first pump for chilling juice to at least a temperature effective for stabilizing the juice. Further continuing the method a chilling trailer is stationed adjacent a tank trailer having a wheeled support platform carrying thereon a juice storage tank fluidly connected to said chiller for receiving chilled juice therefrom, said tank trailer including a second pump having a juice transfer outlet fluidly connected to said storage tank for transferring stored juice out of the storage tank. Yet other steps in the method are operably connecting a generator trailer having a wheeled support platform carrying thereon a generator comprising an internal combustion engine and fuel supply therefor, to provide power for said relocatable plant, and positioning at least one walkway platform along an external periphery of at least one trailer to support movement of personnel thereon. The method concludes by harvesting citrus fruit from the grove and loading harvested citrus fruit into the receiving hopper, and energizing the relocatable plant to extract, chill, and store juice from the citrus fruit.

A more broadly stated embodiment of the method of the invention includes obtaining fresh citrus juice on a commercial scale by stationing a relocatable plant adjacent a citrus grove having fruit ready for harvest, and harvesting and processing citrus fruit through the plant at a rate sufficient to produce at least 500 gallons of juice per hour of operation.

### BRIEF DESCRIPTION OF THE DRAWINGS

Some of the features, advantages, and benefits of the present invention having been stated, others will become apparent as the description proceeds when taken in conjunction with the accompanying drawings, presented for solely for exemplary purposes and not with intent to limit the invention thereto, and in which:

FIG. 1 is an overall view of the relocatable plant of the present invention, wherein FIG. 1A is a side elevation and FIG. 1B is an opposite side elevation;

FIG. 2 illustrates the fruit handling trailer, wherein FIG. 2A shows a side elevation view and FIG. 2B shows a top plan view;

FIG. 3 shows the juicing trailer, wherein FIG. 3A shows a side elevation view and FIG. 3B shows a top plan view;

FIG. 4 depicts the chilling trailer, wherein FIG. 4A shows a top plan view and FIG. 4B shows a side elevation view;

FIG. 5 represents the tank trailer, wherein FIG. 5A shows a top plan view and FIG. 5B shows a side elevation view;

FIG. 6 is a side elevation view of the generator trailer; and

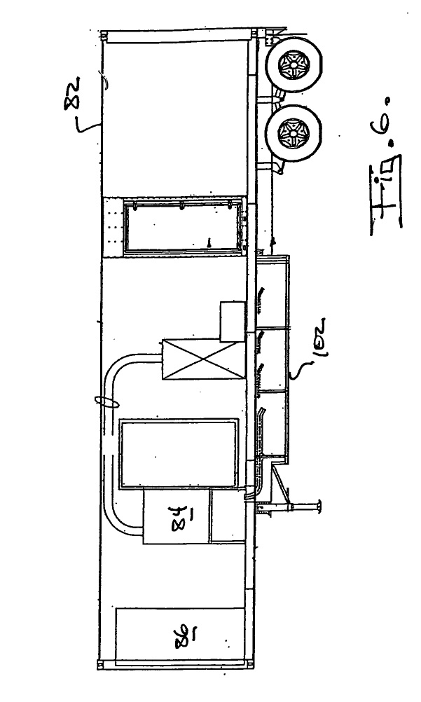

FIG. 7 shows an overall view of the plant of FIG. 1 wherein a fruit receiving trailer and trailer is delivering a full load of fruit for processing according to an embodiment of the present invention.

### DETAILED DESCRIPTION OF THE PREFERRED EMBODIMENTS

The present invention will now be described more fully hereinafter with reference to the accompanying drawings, in which preferred embodiments of the invention are shown. Unless otherwise defined, technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including any definitions, will control. In addition, the materials, methods and examples given are illustrative in nature only and not intended to be limiting. Accordingly, this invention may be embodied in many different forms and should not be construed as limited to the illustrated embodiments set forth herein. Rather, these illustrated embodiments are provided solely for exemplary purposes so that this disclosure will be thorough and complete, and will fully convey the scope of the invention to those skilled in the art. Other features and advantages of the invention will be apparent from the following detailed description, and from the claims.

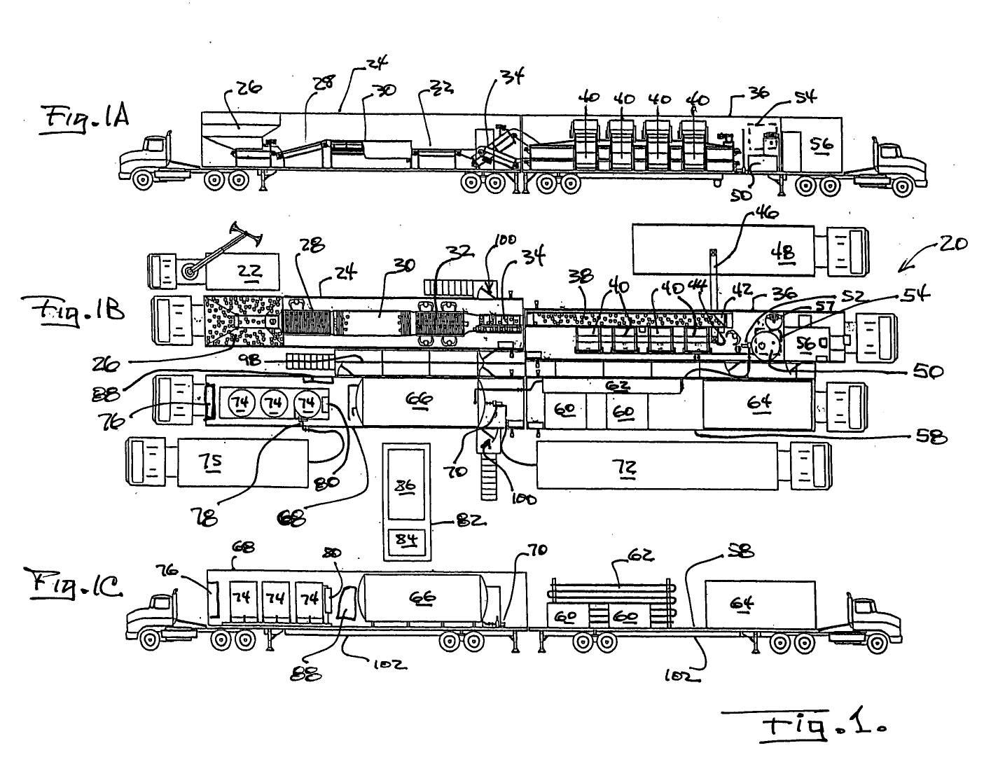

In a preferred embodiment of the invention, the relocatable juicing plant 20 for processing citrus fruit into juice comprises five trailers wherein are disposed the various equipment required for operation. An overall view of the relocatable plant 20 is shown in FIG. 1. In addition, accessory trailers which do not comprise plant equipment may temporarily connect to the relocatable plant 20 for delivering fruit or water to the plant, or for carrying off waste such as citrus peels, or for off-loading processed juice for transportation to a packaging plant. Additionally, fuel deliveries to the power generating trailer may be necessary from time to time, thus requiring the temporary connection thereto of a fuel delivery tanker. Also, as shown in FIG. 1 a “goat” 22 vehicle may be employed for dumping loaded fruit bins into the plant's hopper 26.

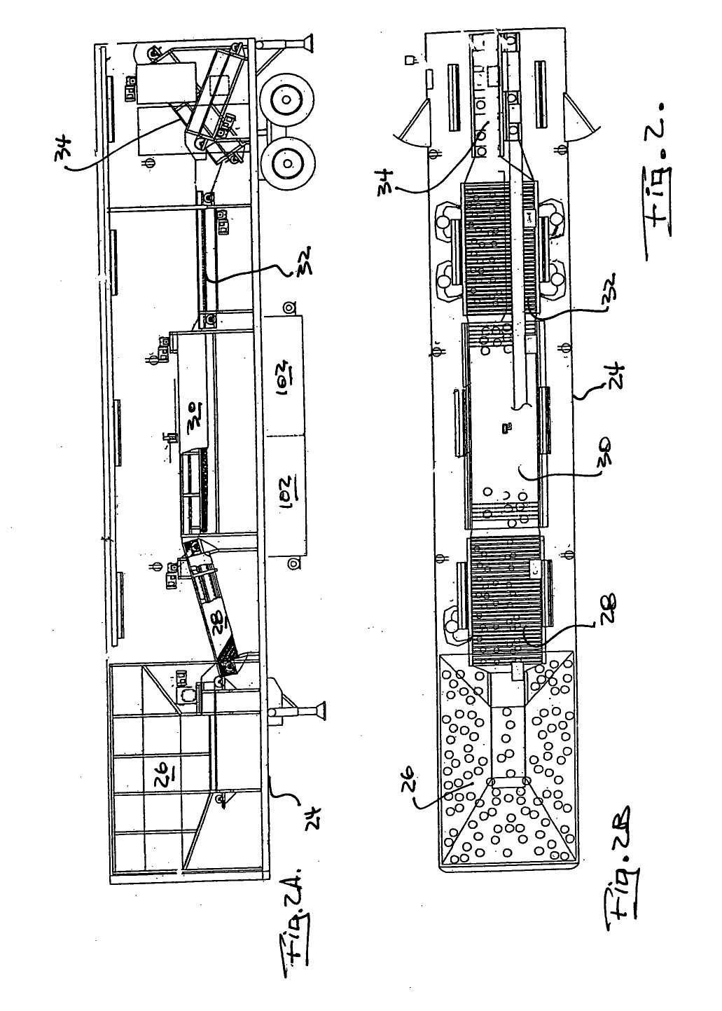

FIG. 2 shows detail of the fruit handling trailer 24 and its equipment. A hopper 26 receives fruit to begin the processing. A conveyor takes fruit from the hopper 26 to a moving spreader table 28 where initial inspection of the fruit takes place. Next, the fruit proceeds to a fruit washer or wash rack 30 whereon it is sprayed with a liquid cleaner, which may include hot water, and is then conveyed to a grading table 32 where unsuitable fruit is culled from the process. A conveyor, preferably a cleated conveyor belt 34, then takes the fruit from the fruit handling trailer 24 to the juicing trailer. The skilled should know that the preferred extractor 40 for use in the invention is manufactured by FMC and provides simultaneous whole fruit extraction with peel oil recovery into a separate receptacle from the extracted juice. The preferred extractor 40 also provides a clean-in-place system allowing at least semiautomated cleaning of the machine, as further described below. Other juice extracting devices, such as those commonly known as Brown extractors, may also be employed in the invention, however, and are intended to be included within the scope of this disclosure.

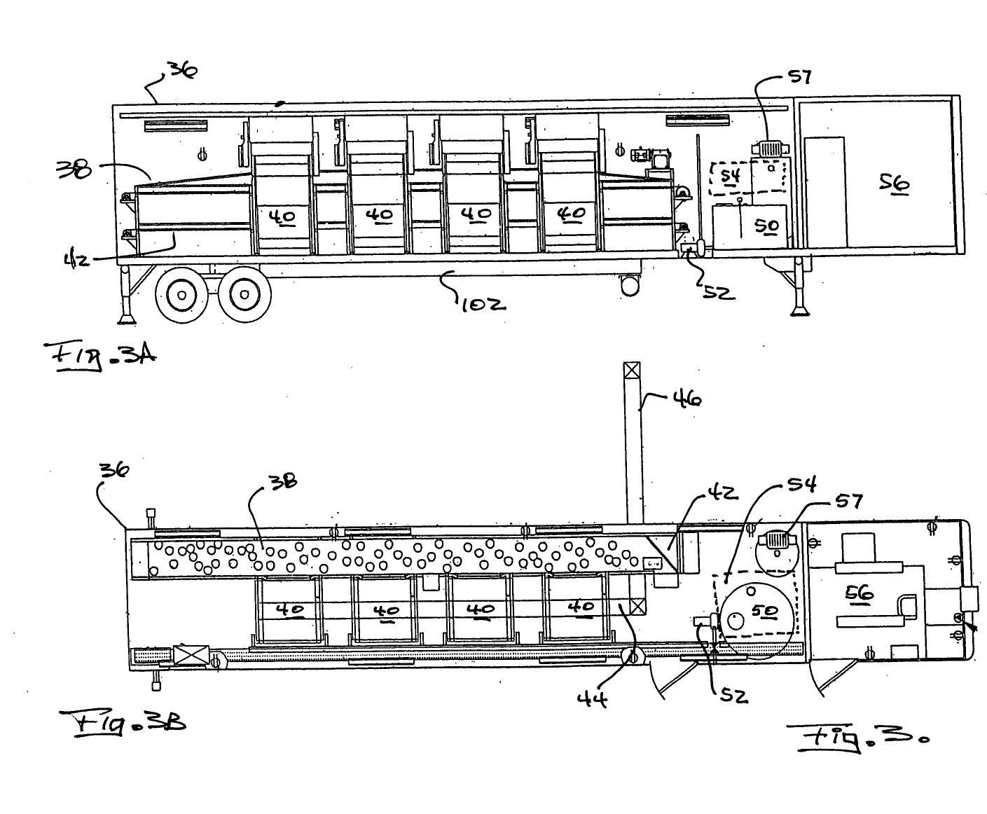

The juicing trailer 36 is shown in more detail in FIG. 3. A conveyor, preferably a tilted conveyor 38 belt carries fruit to an extractor 40, where juice is extracted from the fruit. As shown, the typical juicing trailer will have up to four extractors 40 which are fed by the tilted conveyor 38 belt. Fruit reaching the end of the tilted conveyor 38 are conveyed back to the beginning of the tilted belt by a loop conveyor 42 positioned below the tilted belt conveyor. Additionally, fruit peels to be discarded following extraction are carried by a peel conveyor 44 on which the extractors 40 deposit the peels. The peel conveyor 44 is preferably a screw type conveyor which discharges out the side of the trailer through a peel chute 46, as shown in FIG. 3. Discharged peels may be collected in an appropriate vehicle 48 and disposed by tilling them into the soil of the grove, so as to fertilize and to reduce the need for expensive chemical fertilizers. Discarded peels may also be used for animal feed in nearby farms. The juicing trailer 36, as shown in FIG. 3, also includes a juice surge tank 50 and a surge tank pump 52. Optionally, a juice finisher 54 may be installed downstream from the extractors 40 to remove excess fruit pulp from the juice. Removed pulp is discharged together with the fruit peels, as described. The juice finisher 54 may be positioned on a platform overlying the surge tank 50, so as to conserve space in the plant 20. Extracted juice is collected in the surge tank 50 so that an uninterrupted flow may be created downstream. The surge tank pump 52 then propels juice from the surge tank 50 to the next stage in processing, chilling the juice. The juicing trailer 36 optionally also includes space for a laboratory 56 for quality control and for governmental inspection, as shown in FIGS. 1 and 3. It should be understood, however, that other specific arrangements of equipment and spaces are possible in the invention and that, therefore, the laboratory 56 space may optionally be located in another trailer. The juicing trailer also includes an air compressor 57 which produces compressed air for use in extractor 40 operation and for operating various pneumatically operable valves in the conduits associated with the clean-in-place system, which is further described below.

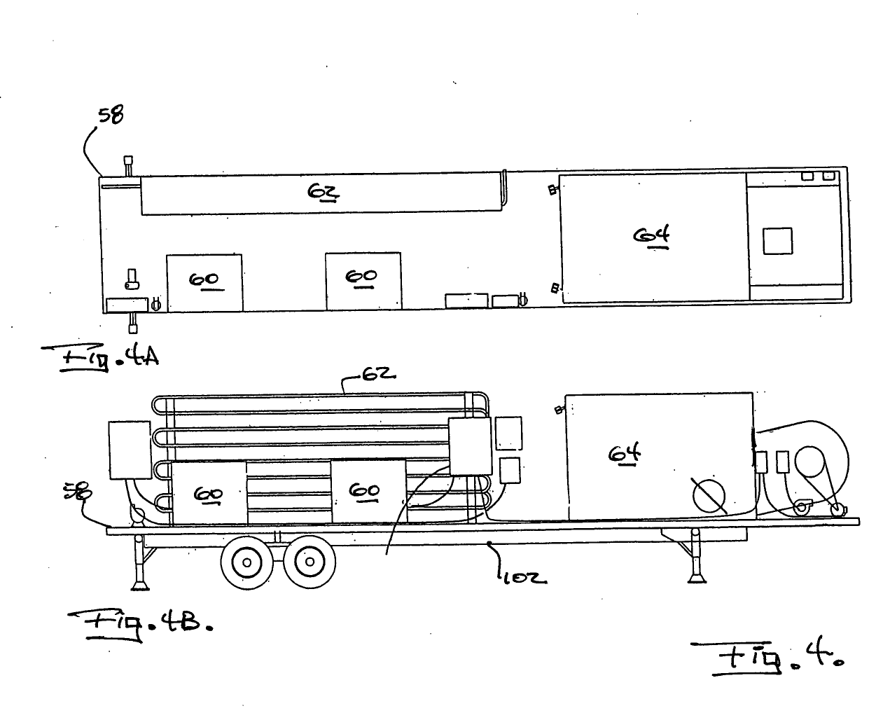

The chilling trailer 58 is shown in FIG. 4 and includes one or more refrigeration compressors 60 employing ammonia as the refrigerant, and a heat transfer system (not shown) coupled to the refrigerant system. The heat transfer system preferably uses polyethylene glycol to transfer heat from the juice to the refrigerant. A chiller 62 comprising an array of conduits containing juice is in contact with the heat transfer system for cooling the juice as it passes through the conduit array. The chilling trailer 58 also includes a cooling tower 64 as part of the chiller. The chiller 62 preferably cools the juice down to at least 34° F.

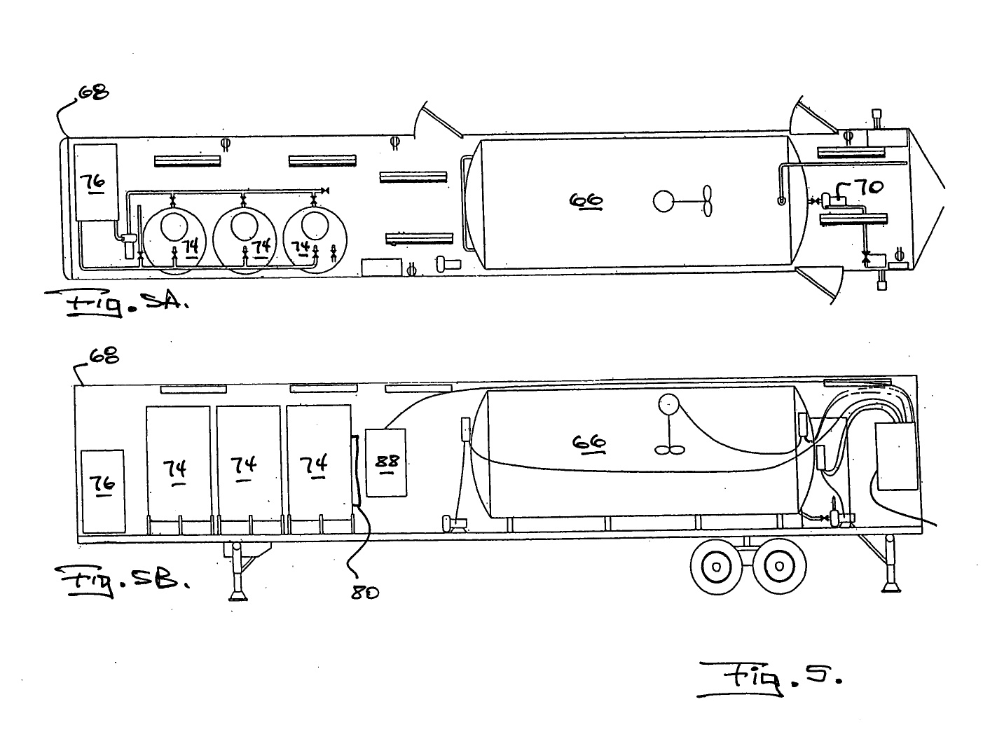

From the chiller 62, the chilled juice proceeds to a cold-wall storage tank 66 positioned in the tank trailer 68. The juice storage tank 66 in the embodiment shown in FIG. 5 holds about 5,000 gallons of juice and is cooled by having a cooling jacket which surrounds the walls of the tank, the cooling jacket being in fluid connection to the chiller 62 apparatus described above. In the cold-wall storage tank, the juice is maintained at a temperature sufficiently cold to effectively stabilize the juice. A storage tank pump 70 is fluidly connected to the juice storage tank to pump juice out to a tanker vehicle 72 which temporarily connects to receive offloaded juice. It should be noted that both the cold-wall storage tank 66 and the surge tank 50 include constant gentle movement of the juice in the tank. In these tanks, the juice is preferably received tangentially along a tank wall to thereby reduce aeration of the juice flowing into the tank.

The tank trailer 68 additionally includes at least one and preferably several water storage tanks 74 and a water heater 76 for generating hot water for a clean-in-place (CIP) system. The CIP comprises a network of conduits (not shown) positioned throughout the relocatable plant 20 to conduct hot water to clean the processing equipment. The network of conduits includes pneumatic valves for flow control, and nozzles from which hot water will spray onto the equipment when the CIP system is in operation. As noted above, compressed air for pneumatic operation of the flow control valves is provided by an air compressor 57 housed in the juicing trailer 36. Chemical disinfectants may also be sprayed through the CIP system, usually diluted in the wash water. Spent CIP wash water is collected and disposed of as typical industrial wastewater. A preferred CIP system includes at least three water storage tanks 74, the first for pre-rinse water, the second for wash solution, and the thid for final rinse water. At least one CIP pump 78 is fluidly connected in the CIP apparatus for providing water pressure. A water delivery tanker 75 may be temporarily connected to the water storage tanks 74 for delivering water for the CIP apparatus. The CIP apparatus also comprises a central controller 80 connected to operate the system, but cleaning nozzles and hoses may be manually operated or automatically operated through the central controller.

The generator trailer 82 supports a power generator comprising an internal combustion engine 84, preferably a Diesel engine and its fuel supply 86. The power generator is operably connected to supply power to all components of the relocatable plant 20. It should be understood that appropriate control devices, switches, and monitoring equipment are positioned in each trailer operably connected to the the equipment therein. In addition, a central control unit 88 from which the entire plant operation may be monitored and controlled may be positioned where convenient relative to the entire plant.

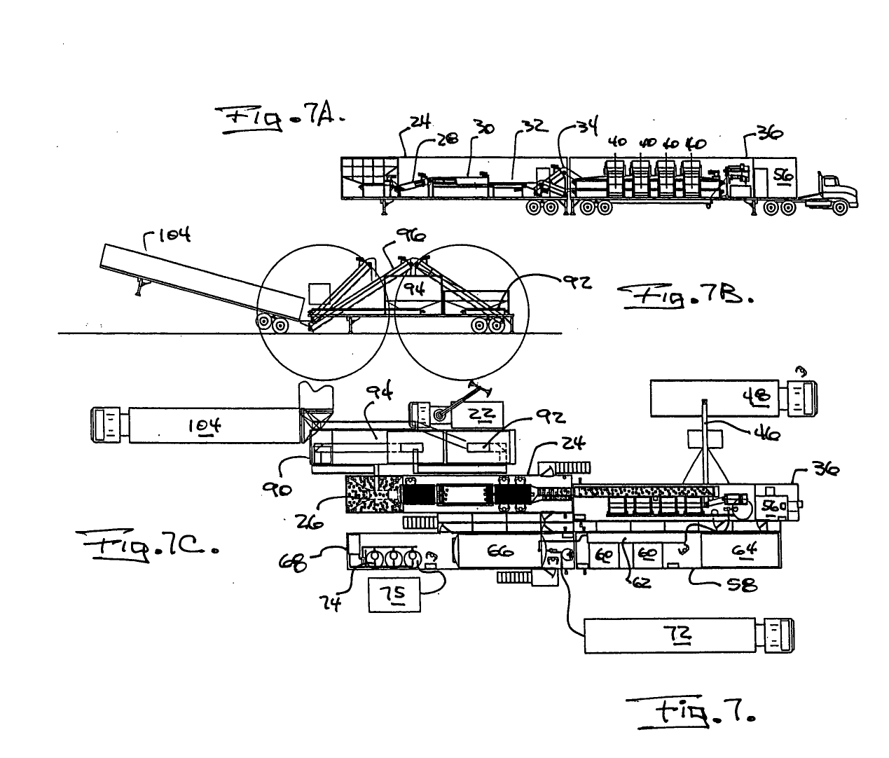

In another preferred embodiment of the relocatable plant 20, a fruit receiving trailer 90 is added to the plurality of trailers described above. As shown in FIG. 7, the fruit receiving trailer 90 preferably includes a load cell 92 for weighing batches of received fruit, and a holding bin 94 from which fruit is then transferred into the hopper 26 located in the fruit handling trailer 24. Fruit goats 22 may dump bins full of fruit directly into the receiving trailer 90. In addition, an entire trailerload of fruit may be dumped into a receiving conveyor 96 which loads fruit into the receiving trailer 90, as shown in FIG. 7. A trailer 104 full of fruit for processing is inclined on a hydraulic lift, as known in the art (not shown), and fruit is conveyed to the receiving trailer 90. Addition of the receiving trailer 90 to the relocatable plant 20 allows for better control of the input flow of fruit into the plant, by essentially providing a reservoir of fruit so that if goat 22 traffic is interrupted or slow, the plant may continue to process at full capacity.

Additional features of a preferred embodiment of the relocatable juicing plant 20 for citrus fruit include at least one walkway platform 98 detachably positioned along an external periphery of one or more of the described trailers. As shown in FIG. 1, the fruit handling trailer 24 and juicing trailer 36 are positioned interconnected back-to-back, and the chilling trailer 58, and tank trailer 68 are similarly positioned next to the fruit handling trailer 24 and juicing trailer. This arrangement of trailers generally forms a rectangular plant, with one pair of trailers spaced apart from another pair of trailers. The walkway platforms 98 are detachably connected between the pairs of spaced apart trailers to provide ingress and egress for personnel. In addition, a plurality of entryways 100 into the trailers may be provided either along the central walkway, or along the outer periphery of the rectangle, as shown in FIG. 1. These peripheral entryways 100 would also have at least a portion of a walkway connected thereto. Preferably, for relocation of the plant 20 walkways, stairs, connecting hoses and cables may be disconnected and carried in cargo containers 102 extending along an underside of the trailers.

In operation, as noted above and shown in FIG. 1, the four principal trailers are positioned and connected back-to-back to each other. It is through the rearward opening of these trailers that the operating connections are made primarily between trailers, as illustrated in FIG. 1. In this arrangement, it is useful to provide a removable cover or seal to keep rain, dust, and other weather effects from coming into the plant through the joint formed by the back ends of the trailers. Other features of the invention include wherein each said trailer optionally includes a mechanical ventilation apparatus effective for exchanging the air in the trailer a predetermined number of times per hour, and the mechanical ventilation apparatus comprises at least one filter effective in reducing dust in the air.

Method aspects of the present invention include a method of obtaining fresh citrus juice on a commercial scale at the grove. The method comprises stationing the described relocatable plant 20 adjacent a citrus grove having fruit ready for harvest, and processing citrus fruit through the plant at a rate sufficient to produce at least 500 gallons of juice per hour of operation. In the method, processing continues until harvesting the grove has been completed. A preferred embodiment of the method includes wherein citrus fruit harvested is extracted into juice within four hours of harvest and the relocatable plant 20 is stationed on-site at the grove.

From the description and the figures, the skilled should appreciate that the present relocatable juicing plant 20 for citrus fruit provides several important efficiencies over conventional citrus fruit juice production. First, the handling of the fruit is greatly reduced, as the fruit goes directly from the tree to the processing plant 20. Second, pre-processing storage of the fruit is substantially reduced or completely eliminated, as there is no need for collecting the fruit for transport to a distant, regional processing plant. Third, the time from harvest to juicing is drastically reduced, especially when the present juicing plant 20 is stationed on-site at the grove, being in the order of about two hours from picking of the fruit to when the juice has been extracted and is stored under refrigeration. In a conventional system, there is a delay of from about fourteen hours to about seventy six hours from the time fruit is picked to the time juice is extracted and stored. It is known that the length of time during which fruit is stored prior to extraction of the juice causes the fruit to undergo dehydration, with consequent loss of juice yield. Because the time between harvesting and extracting juice has been so greatly reduced, the present invention produces surprisingly increased yields of fresh juice.

Moreover, in the present invention as illustrated in FIG. 1, the distance traveled within the processing plant 20 by the juice after extraction has been greatly reduced when compared to a conventional stationary plant. In a typical conventional stationary plant the travel distance of juice between extraction and storage is at least from approximately 350 to 700 feet and requires many pumps. In the present relocatable plant 20, however, the juice travels about 95 feet or less and is handled by only two pumps to minimize bruising of the juice. For example, in the invention the juice travels about 25 feet or less from extraction to the surge tank 50. From the surge tank 50 to the chiller 62 the distance is approximately 40 feet, and the juice passes through a single pump on its way there. From the chiller 62 to the cold-wall storage tank 66 the juice travels about 10 feet. Finally, when juice is transferred from the storage tank 66 to a tanker truck the travel distance is approximately 20 feet, and the juice is handled by a second pump. Juice travel time between each of these stages is under one minute and often substantially less. Total travel time of the juice from extraction to cold-wall storage tank 66 is about ten minutes or less. This greatly decreased travel distance for the juice and minimized pump handling contribute to limiting the amount of aeration suffered by the juice, which reduces juice “bruising” or deterioration. The equipment, the arrangement of the processing equipment within the trailers, and the physical arrangement of the trailers in relation to each other have been selected to reduce bruising of the fruit before extraction and aeration of the juice after extraction, thus creating a naturally tasting fresh product on a commercial scale. The invention, thus, produces a fresh juice which does not require the addition of flavor enhancers. Furthermore, because juice produced by this apparatus and process will typically contain a lower microbial load than conventionally obtained juice, it may be possible to Pasteurize this juice at a lower temperature and/or for a shorter time. Pasteurization for less time or at a lower temperature would be advantageous since it is known that standard Pasteurization degrades the flavor notes of fresh juice, requiring that flavor additives be later mixed into the juice.

Accordingly, in the drawings and specification, there has been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

1. A relocatable plant for citrus juice extraction, said plant comprising:
a handling trailer having a wheeled support platform carrying thereon a fruit receiving hopper, a fruit washer, a sorting conveyor table, and a discharge conveyor;
a juicing trailer having a wheeled support platform carrying thereon a feed conveyor positioned to receive fruit from said discharge conveyor, a plurality of juice extractors having fruit reamers and fed by said feed conveyor, a peel conveyor positioned to convey fruit peels from said plurality of extractors to a peel discharge chute, a refrigerated surge tank downstream from said plurality of extractors to receive extracted juice, and a first pump in fluid connection with said surge tank;
a chilling trailer having a wheeled support platform carrying thereon a chiller comprising a plurality of refrigerated pipes in fluid connection with said first pump for chilling juice to at least a temperature effective for stabilizing the juice;
a tank trailer having a wheeled support platform carrying thereon a juice storage tank fluidly connected downstream from said chiller for receiving chilled juice therefrom, and a second pump having a juice transfer outlet fluidly connected to said storage tank for transferring stored juice to a transport tanker;
a generator trailer having a wheeled support platform carrying thereon a generator comprising an internal combustion engine and fuel supply therefor, said generator operably connected to provide power for said relocatable plant;
at least one walkway platform detachably positioned along an external periphery of at least one trailer selected from said handling, juicing, chilling, tanker, and generator trailers to support movement of personnel thereon; and
a plurality of entryways adjacent said plurality of walkways for ingress and egress of personnel.

2. The relocatable plant of claim 1, wherein said handling, juicing, chilling, and tanker trailers each comprises a forward end and a rearward end spaced apart therefrom, and each two of said trailers are positioned so as to allow a connection therebetween along their rearward ends when said relocatable plant is in operation.

3. The relocatable plant of claim 1, wherein at least said handling, juicing, and tanker trailers is each fully enclosed by a plurality of external walls and a roof.

4. The relocatable plant of claim 1, wherein said handling trailer and said juicing trailer each further comprises at least one ventilation opening along an external wall or roof.

5. The relocatable plant of claim 1, wherein each said trailer further comprises a tractor truck connected thereto.

6. The relocatable plant of claim 1, further comprising a clean-in-place apparatus having an inlet, at least one tank for cleaning fluid and a third pump, said pump fluidly connecting said at least one tank with a plurality of pipes each having at least one nozzle positioned to discharge the cleaning fluids on predetermined plant equipment.

7. The relocatable plant of claim (above), wherein at least one nozzle is manually operable.

8. The relocatable plant of claim (two above), wherein said clean-in-place apparatus further comprises a central controller connected to operate said apparatus.

9. The relocatable plant of claim (three above), wherein said at least one tank is positioned in said tanker trailer.

10. The relocatable plant of claim (four above), in combination with a tanker truck fluidly connected with said at least one tank.

11. The relocatable plant of claim 1, further comprising a plurality of substantially weatherproof covers positioned to provide weather protection between at least two of said trailers.

12. The relocatable plant of claim 1, further comprising a laboratory positioned in a trailer selected from said handling trailer, juicing trailer, chilling trailer, and tanker trailer.

13. The relocatable plant of claim 1, further comprising a laboratory positioned in said juicing trailer.

14. The relocatable plant of claim 1, wherein each said trailer optionally includes a mechanical ventilation apparatus effective for exchanging the air in the trailer a predetermined number of times per hour.

15. The relocatable plant of claim (above), wherein said mechanical ventilation apparatus comprises at least one filter effective in reducing dust in the air.

16. The relocatable plant of claim 1, wherein each said trailer comprises a controller operably connected to control equipment positioned in said trailer.

17. The relocatable plant of claim 1, in combination with a transport truck positioned to receive peels from said peel discharge chute.

18. The relocatable plant of claim 1, in combination with a tanker truck positioned in fluid connection with said second pump for transporting juice to away from said plant for further processing or packaging.

19. The relocatable plant of claim 1, in combination with a goat vehicle unloading citrus fruit into said receiving hopper.

20. The relocatable plant of claim 1, in combination with a citrus fruit grove having fruit ready for harvesting and adjacent which grove said relocatable plant is stationed.

21. The relocatable plant of claim 1, wherein the fluid connection distance between each of said juicing, chilling, and tank trailers is no more than about forty feet.

22. A method of obtaining fresh citrus juice on a commercial scale, the method comprising stationing the relocatable plant of claim 1 adjacent a citrus grove having fruit ready for harvest, and harvesting and processing citrus fruit through the plant at a rate sufficient to produce at least 500 gallons of juice per hour of operation.

23. The method of claim 22, wherein processing continues until harvesting the grove is completed.

24. The method of claim 22, wherein citrus fruit harvested is extracted into juice within 4 hours of harvest.

25. The method of claim 22, wherein adjacent consists of stationing on-site at the grove.

26. A method of extracting citrus fruit juice, the method comprising:
stationing on site at a citrus grove having citrus fruit about ready for harvest a handling trailer having a wheeled support platform carrying thereon a fruit receiving hopper, a fruit washer, a sorting conveyor table, and a discharge conveyor;
stationing adjoining the handling trailer a juicing trailer having a wheeled support platform carrying thereon a feed conveyor positioned to receive fruit from said discharge conveyor, a plurality of juice extractors having fruit reamers and fed by said feed conveyor, a peel conveyor positioned to convey fruit peels from said plurality of extractors to a peel discharge chute, a refrigerated surge tank downstream from said plurality of extractors to receive extracted juice, and a first pump in fluid connection with said surge tank;
stationing a chilling trailer adjacent said juicing trailer, the chilling trailer having a wheeled support platform carrying thereon a chiller comprising a plurality of refrigerated pipes in fluid connection with said first pump for chilling juice to at least a temperature effective for stabilizing the juice;
stationing adjacent said chilling trailer a tank trailer having a wheeled support platform carrying thereon a juice storage tank fluidly connected to said chiller for receiving chilled juice therefrom, said tank trailer including a second pump having a juice transfer outlet fluidly connected to said storage tank for transferring stored juice out of the storage tank;
operably connecting a generator trailer having a wheeled support platform carrying thereon a generator comprising an internal combustion engine and fuel supply therefor, to provide power for said relocatable plant;
positioning at least one walkway platform along an external periphery of at least one trailer selected from said handling, juicing, chilling, tanker, and generator trailers to support movement of personnel thereon;
harvesting citrus fruit from the grove and loading harvested citrus fruit into the receiving hopper; and
energizing the relocatable plant to extract, chill, and store juice from the citrus fruit.

27. A method of obtaining fresh citrus juice on a commercial scale, the method comprising stationing a relocatable plant adjacent a citrus grove having fruit ready for harvest, and harvesting and processing citrus fruit through the plant at a rate sufficient to produce at least 500 gallons of juice per hour of operation.

28. The method of claim 27, wherein processing continues until harvesting the grove is completed.

29. The method of claim 27, wherein citrus fruit harvested is extracted into juice within 4 hours of harvest.

30. The method of claim 27, wherein adjacent consists of stationing on-site at the grove.
